(19) United States
(12) Patent Application Publication
(10) Pub. No.: US 2022/0074712 A1
(43) Pub. Date: Mar. 10, 2022

(54) Drone for Detecting and Removing Mines

(71) Applicant: Byeong Hu OH, Changwon-si (KR)

(72) Inventor: Byeong Hu OH, Changwon-si (KR)

(21) Appl. No.: 17/076,049

(22) Filed: Oct. 21, 2020

(30) Foreign Application Priority Data
Sep. 7, 2020 (KR) 10-2020-0113549

(51) Int. Cl. F41H 11/16; F41H 11/136; B64C 39/02

(52) U.S. Cl. CPC F41H 11/16; F41H 11/136; B64C 2201/12; B64C 2201/027; B64C 2201/108; B64C 39/024

(57) ABSTRACT

The present invention relates to a drone for detecting and removing mines laid on or under the ground, and more specifically, to a drone for detecting and removing mines, which can perform tasks that are dangerous for humans to perform themselves on behalf of the humans, and detect and remove mines by being deploying in a dangerous area where war may break out, such as a military boundary line or the like, as a detection drone for detecting mines and a removal drone for removing the mines detected by the detection drone are configured as a pair, and detection and removal of the mines are performed by the drone.

### BACKGROUND OF THE INVENTION

### Field of the Invention

The present invention relates to a drone for detecting and removing mines laid on or under the ground, and more specifically, to a drone for detecting and removing mines, which can perform tasks that are dangerous for humans to perform themselves on behalf of the humans, and detect and remove mines by being deploying in a dangerous area where war may break out, such as a military boundary line or the like, as a detection drone for detecting mines and a removal drone for removing the mines detected by the detection drone are configured as a pair, and detection and removal of the mines are performed by the drone.

### Background of the Related Art

Generally, a drone is a type of unmanned aerial vehicle, referring to an aerial vehicle flying by radio waves without a human on board.

Drones like this are used in various fields, especially for firefighting, rescue, spraying pesticides or the like.

As a conventional technique related to drones, there is a fire fighter drone capable of launching grenade-shaped extinguisher, proposed in Korean Laid-opened Patent No. 10-2017-0025386.

The above patent proposes a fire fighter drone capable of launching a grenade-shaped extinguisher, and the fire fighter drone includes: a fire tracking unit for tracking a fire origin on the basis of thermal imaging data of a built-in thermal imaging camera and heat sensing data of a heat sensing sensor unit; a throwing unit capable of continuously launching a plurality of grenade-shaped extinguishers, and adjusting a firing angle and a firing distance of the fire extinguisher on the basis of a result of tracking the fire tracking unit; and a moving unit including a plurality of propellers and adjusting a moving direction.

As another conventional technique, there is a drone for rescue at sea and a system for rescue at sea using thereof, proposed in Korean Laid-opened Patent No. 10-2017-0013100.

The patent proposes a drone for marine rescue including: a drone body; a drone GPS module stored in the drone body, and generating drone position data by sensing the position of the drone body; a flying propeller installed outside the drone body to be able to fly; a tube holder formed in the lower part of the drone body, and holding the lifesaving ring tube to be separable; and a controller including an emergency signal receiving part stored in the drone body and receiving an emergency signal, including castaway position data, from an external marine control center, a flight control part controlling the flying propeller to move to the upper part of the castaway by comparing the drone position data with the castaway position data, and a throwing control part controlling the tube holder to throw the lifesaving ring tube to the castaway.

All the conventional techniques described above are used for firefighting, lifesaving, and spraying pesticide using drones, and there is a limit in using the drones for the purpose of detecting and removing mines as described in the present invention.

### SUMMARY OF THE INVENTION

Accordingly, the present invention has been made in view of the above-mentioned problems occurring in the prior art, and it is an object of the present invention to provide a drone for detecting and removing mines laid on or under the ground, which can perform tasks that are dangerous for humans to perform themselves on behalf of the humans, and detect and remove mines by being deploying in a dangerous area where war may break out, such as a military boundary line or the like, as a detection drone for detecting mines and a removal drone for removing the mines detected by the detection drone are configured as a pair, and detection and removal of the mines are performed by the drone.

In addition, another object of the present invention is to provide a drone for detecting and removing mines, which can fundamentally prevent damage caused by the mines by providing a coating device capable of applying a fluorescent material at one side of the detection drone and applying, when a mine is detected, the fluorescent material at the same time as mapping the location of the mine.

In addition, still another object of the present invention is to provide a drone for detecting and removing mines, which enhances accuracy of detecting mines by installing a distance sensor in the detection drone to move along a terrain to detect mines laid on or under the ground so that the detection drone may fly at an altitude within a predetermined range from the ground by the distance sensor.

In addition, still another object of the present invention is to provide a drone for detecting and removing mines, which enhances accuracy of removing mines by installing a separate mine detector in an explosive contained in a container box at one side of the removal drone and additionally configuring a driving device so that the explosive itself may detect and move to the exact location of a mine and explodes by itself.

In a method of detecting and removing mines using a drone according to the present invention, a method of removing a mine using an unmanned drone includes the steps of detecting a mine using a detection drone equipped with a mine detection device that can detect mines laid on or under the ground, and removing the mine by dropping an explosive using a removal drone loaded with the explosive at the location of the mine secured by the detection drone.

The drone for detecting and removing mines according to the present invention has a remarkable effect of performing tasks that are dangerous for humans to perform themselves on behalf of the humans, and detecting and removing mines by being deploying in a dangerous area where war may break out, such as a military boundary line or the like, as a detection drone for detecting mines and a removal drone for removing the mines detected by the detection drone are configured as a pair, and detection and removal of the mines are performed by the drone, an effect of fundamentally preventing damage caused by the mines by providing a coating device capable of applying a fluorescent material at one side of the detection drone and applying, when a mine is detected, the fluorescent material at the same time as mapping the location of the mine, an effect of enhancing accuracy of detecting mines by installing a distance sensor in the detection drone to move along a terrain to detect mines laid on or under the ground so that the detection drone may fly at an altitude within a predetermined range from the ground by the distance sensor, and an effect of enhancing accuracy of removing mines by installing a separate mine detector in an explosive contained in a container box at one side of the removal drone and additionally configuring a driving device so that the explosive itself may detect and move to the exact location of a mine and explodes by itself.

### BRIEF DESCRIPTION OF THE DRAWINGS

FIG. 1 is an exemplary view showing the configurations of a detection drone and a removal drone according to the present invention.

FIG. 2 is an exemplary view showing the configuration of a detection drone according to the present invention.

FIG. 3 is an exemplary view showing the configuration of a removal drone according to the present invention.

FIG. 4 is a perspective view showing the configuration of an explosive according to the present invention.

FIG. 5 is a block diagram showing the configuration of an explosive according to the present invention.

FIG. 6 is an exemplary view showing the operation of the present invention.

DESCRIPTION OF SYMBOLS

| | |
|---|---|
| 10: Detection drone | 11: Drone body |
| 12: Frame | 13: Propeller |
| 14: Motor | 15: Camera |
| 20: Mine detection device | 21: Mine detector |
| 22: Fixing frame | 23: Storage box |
| 24: Spray nozzle | 30: Removal drone |
| 31: Container box | 32: Shock absorbing box |
| 40: Explosive | 41: Explosive body |
| 42: Wheel | 43: Driving means |
| 44: Mine detector | 45: Gunpowder |
| 46: Electronic detonator | 47: Grape bullet |
| 48: Communication device | M: Mine |

### DETAILED DESCRIPTION OF THE PREFERRED EMBODIMENT

The present invention relates to a drone for detecting and removing mines laid on or under the ground, and more specifically, to a drone for detecting and removing mines, which can perform tasks that are dangerous for humans to perform themselves on behalf of the humans, and detect and remove mines by being deploying in a dangerous area where war may break out, such as a military boundary line or the like, as a detection drone for detecting mines and a removal drone for removing the mines detected by the detection drone are configured as a pair, and detection and removal of the mines are performed by the drone.

Hereinafter, a preferred embodiment of the present invention will be described in detail with reference to the accompanying drawings.

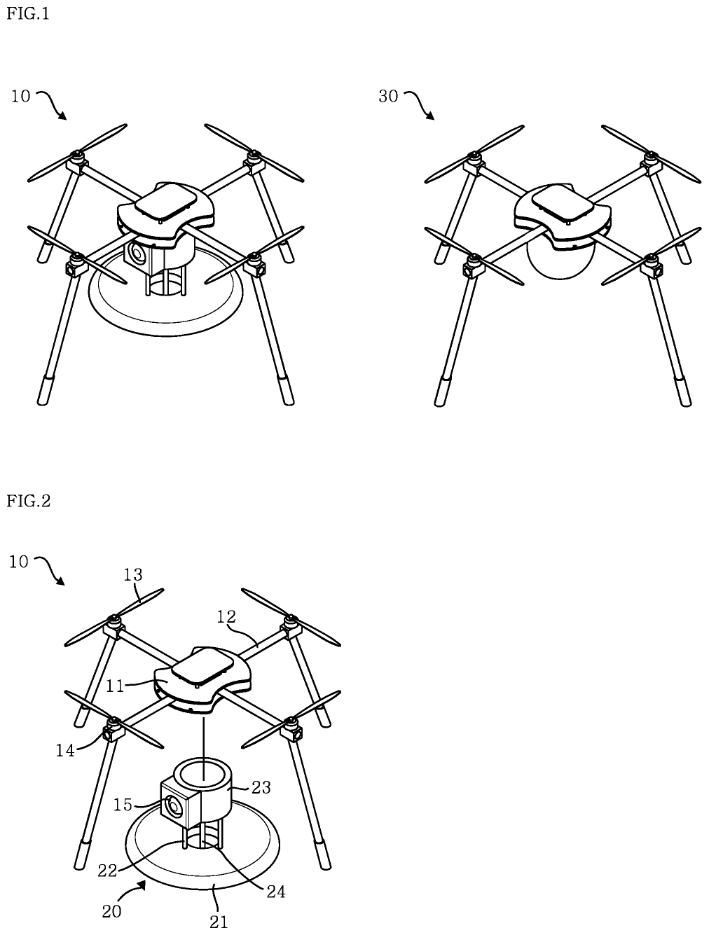

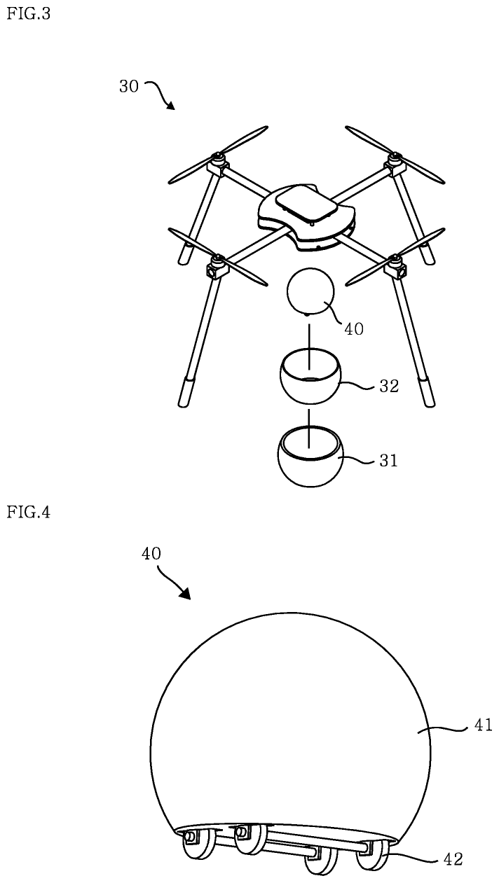

FIG. 1 is an exemplary view showing the configurations of a detection drone and a removal drone according to the present invention, FIG. 2 is an exemplary view showing the configuration of a detection drone according to the present invention, and FIG. 3 is an exemplary view showing the configuration of a removal drone according to the present invention. The drone for detecting and removing mines according to the present invention includes a detection drone 10 equipped with a mine detection device 20 capable of detecting a mine M laid on or under the ground, and a removal drone 30 for removing the mine by explosion of an explosive by dropping the explosive 40 at the location of the mine secured by the detection drone 10, and the removal drone 30 waits at a predetermined distance from the explosive after the explosive 40 is installed, monitors the explosion process of the explosive exploded by a command of the control unit, sends monitored information to the control unit, and confirms whether the mine M remains after explosion of the explosive.

First, the drone fuselage of the detection drone 10 includes a drone body 11 in which various components such as sensors are fixed, a frame 12 fixedly coupled to the drone body 11, a propeller 13 fixed to one end of the frame 12 to rotate and generate lift so that the drone may fly, a motor 14 for driving the propeller 13, a battery for supplying power to the motor 14, a gyro sensor for controlling the drone, a GPS module for detecting a position of the drone, and a communication unit for communicating with a controller, and the controller transmits various commands through the communication unit, and the drone executes these commands.

In the case of the present invention, the mine detection device 20 for detecting mines is additionally configured at one side of the detection drone 10, and a camera 15 capable of confirming flight status or a flight area of the drone is attached. An image captured by the camera 15 is transmitted to the operator side, i.e., to the control unit, of the drone through the communication unit, and the image is also stored in the memory provided in the drone itself.

Since the mine detection device 20 generates an electromotive force in a coil like a conventionally used metal detector and a change occurs in the electromotive force when a metal material is detected at a relatively close distance, it may use a mine detector of an electromotive force type, which is a method of sensing an electromotive force, or the mine detection device 20 may use an ultrasonic mine detector to detect mines that do not respond well to the mine detector of an electromotive force type, such as plastic mines.

The detection drone 10 flies from the ground, detects a mine using a magnetic field sensor, and maps the location of a detected mine and applies a fluorescent material at the same time, and the removal drone 30 installs the explosive 40 around the mine using information on mapping the location and applying the fluorescent material by the detection drone 10, and then removes the mine by exploding the explosive according to a command of the control unit.

That is, when the location of a mine is identified by the mine detection device 20, information on the identified location is mapped in association with the GPS, and after the location information is mapped, the fluorescent material, i.e., a fluorescent paint, stored in the storage box 23 is sprayed around the mine through the spray nozzle 24 to mark the location of the mine.

In addition, the detection drone 10 is equipped with a distance sensor to move along a terrain to detect a mine M laid on or under the ground, and flies at an altitude within a predetermined range from the ground by the distance sensor.

Although a general mine is completely exposed on the ground in some cases, the mine is partially or completely laid under the ground in most cases. When a mine is laid under the ground, it may be difficult for the mine detection device to detect the mine when the detection drone 10 flies too far from the ground, and reliability of mine detection may be enhanced by measuring a distance from the ground using the distance sensor and controlling the detection drone 10 to fly while maintaining the distance between the drone and the ground, i.e., the altitude, within a predetermined range using the measured distance value.

It is automatically controlled to increase the driving speed of the propeller 13 by the motor 14 to raise the drone fuselage in a direction away from the ground when the distance value between the drone fuselage and the ground sensed by the distance sensor is smaller than a set value and, on the contrary, to decrease the driving speed of the propeller 13 by the motor 14 when the distance value is larger than the set value so that the drone may fly at a lowered altitude.

After the location of a mine is secured by the detection drone 10, the mine is removed using the removal drone 30 loaded with the explosive 40.

The removal drone 30 waits at a predetermined distance from the explosive after the explosive 40 is installed, monitors the explosion process of the explosive exploded by a command of the control unit, sends monitored information to the control unit, and confirms whether the mine remains after explosion of the explosive.

That is, since the removal drone 30 or living creatures including humans around the mine may be damaged when the explosive 40 is immediately exploded after being installed in the mine M, a warning is issued during a predetermined time period after the explosive is installed, and the mine is removed by performing explosion of the explosive thereafter.

Particularly, since the explosive 40 operates only when an explosion signal is sent from a relatively close position in many cases, explosion may not occur with a signal sent directly from the operator of the drone to the explosive. Accordingly, effectiveness of removing mines may be enhanced as the removal drone 30 receives an explosion signal from the operator and sends the explosion signal to the explosive to explode the explosive.

In addition, an infrared detection device (not shown) may be added at one side of the drone fuselage 10 to confirm whether a living creature is within the killing radius of a mine in anticipation of explosion of the mine by explosion of an explosive after the explosive is supplied, and a warning device (not shown) may be additionally installed to give a warning signal to the living creature when there is a living creature after confirmation of the infrared detection device.

That is, although the explosive 40 carried on the drone fuselage has a comparatively weak explosive power for explosion of the mine, a buried mine has a comparatively strong explosive power for the purpose of killing people or destroying tanks, and explosion of the mine may damage living creatures including people around the mine.

To prevent this case, unnecessary damage to living creatures can be prevented by adding an infrared detection function to the camera itself or configuring an infrared detection device separated from the camera to confirm existence of living creatures and give a warning when living creatures are found.

The warning device may use an emergency signal such as a commonly used siren, a warning sound through a voice, and various other sounds or lights.

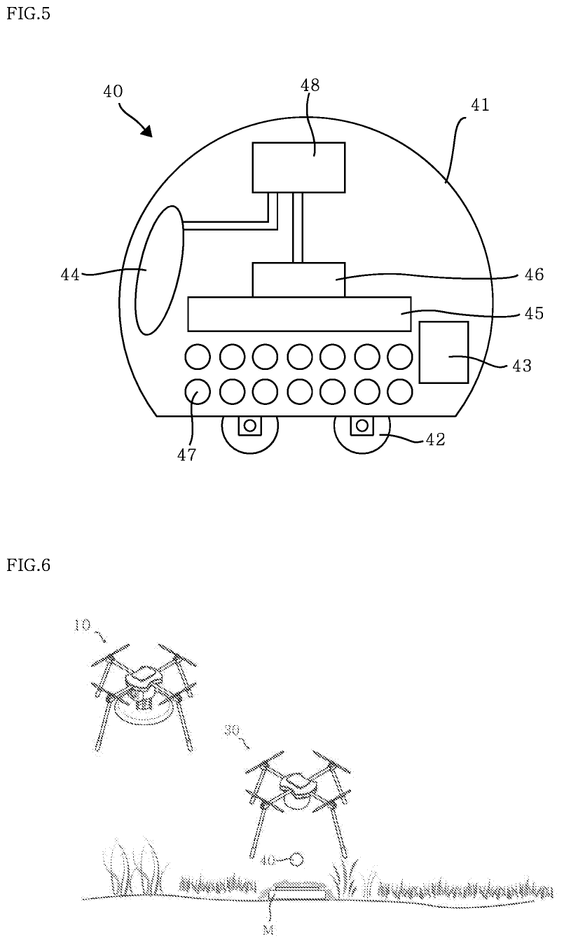

FIG. 4 is a perspective view showing the configuration of an explosive according to the present invention, and FIG. 5 is a block diagram showing the configuration of an explosive according to the present invention. The removal drone 30 is provided with a container box 31 capable of storing the explosive 40, and the explosive 40 stored in the container box 31 is stored in a shock absorbing box 32 not to be randomly exploded by an external shock. The explosive 40 is configured of an explosive body 41 for storing gunpowder 45 and grape bullets 47, an electronic detonator 46 for explosion of the gunpowder 45, a wheel 42 and a driving means 43 for moving the explosive body 41, a mine detector 44 for detecting an exact location of a mine, and a communication device 48 for communicating with the control unit.

That is, the explosive 40 is stored in the container box 31 installed in the removal drone 30, and specifically, the explosive 40 is stored in the shock absorbing box 32 made of a material with high elasticity such as rubber to prevent random explosion occurred by an external impact. The gunpowder 45 and the grape bullets 47 are stored in the spherical explosive body 41, and the gunpowder 45 is ignited and exploded by the electronic detonator 46.

By explosion of the gunpowder 46, the grape bullets 47 are fired toward the bottom of the explosive body 41, i.e., toward the direction where the wheels 42 are installed, and the mine M laid on or under the ground is exploded.

In addition, when the explosive 40 is not dropped at the correct location of the mine M although the explosive 40 is dropped by the removal drone 30, the location of the mine M is identified by the mine detector 44 installed in the explosive body 41, and the wheels 42 installed in the explosive body 41 and the driving means 43 for driving the wheels 42 move the explosive 40 according to the identified location of the mine M.

Accordingly, when the explosive 40 is positioned above the mine M, information is sent to the control unit by the communication device 48, and thereafter, the electronic detonator 46 operates and ignites the gunpowder 45 according to a command of the control unit, and the explosive 40 is exploded.

Meanwhile, a collection device for collecting the explosive 40 may be additionally installed at one side of the removal drone 30.

That is, the collection device may be configured of a gripper capable of picking up explosives, a motor for operating the gripper, and a lifting device capable of lifting the gripper into a storage box, and in the case of the explosive, since explosion occurs not by an impact, but by an electrical signal, the explosion may not occur for various reasons such as a communication error, an unexploded explosive or the like. In this case, the explosive may be collected through the collection device, and the collected explosive may be moved, dropped and removed at a safe place.

When a mine is not removed for some reason, such as a defect of the explosive or the like, the drone should be sent again to detect the mine. To prevent this situation, the mine detection device stores the location of a detected mine as a GPS signal as soon as the mine is detected, and transmits the location to the user's controller through the communication device.

The location of a mine identified in this way may be used to remove the mine by immediately sending a new explosive.

In the embodiment as described above, the detection drone 10 and the removal drone 30 may be configured to be provided with a temperature sensor, a humidity sensor, and a wind speed sensor at one side of the drones to sense a temperature, a humidity and a wind speed at the location where the drone flies and send them to the control unit.

That is, the temperature sensor, the humidity sensor, and the wind speed sensor are installed at one side of the drones, and the control unit (controller) may receive information sensed by the sensors through the communication unit and confirm information on the places where the drone is flying.

Such information may be conveniently used when a military operation is conducted in an area where the drone flies, and in some cases, information on biochemical warfare may be confirmed by providing a gas detection sensor.

FIG. 6 is an exemplary view showing an embodiment of the present invention, which schematically shows a method in which the detection drone 10 moves to detect another mine after detection of a mine M laid on or under the ground is completed by the detection drone 10, and the removal drone 30 removes the mine by dropping an explosive 40.

At this point, it may be configured such that the moving path along which the detection drone 10 moves to detect a mine is transferred to the removal drone 30, and the removal drone 30 moves along the received moving path while having a predetermined delay time with respect to the detection drone 10.

As a result, the drone for detecting and removing mines according to the present invention has a remarkable effect of performing tasks that are dangerous for humans to perform themselves on behalf of the humans, and detecting and removing mines by being deploying in a dangerous area where war may break out, such as a military boundary line or the like, as a detection drone for detecting mines and a removal drone for removing the mines detected by the detection drone are configured as a pair, and detection and removal of the mines are performed by the drone, an effect of fundamentally preventing damage caused by the mines by providing a coating device capable of applying a fluorescent material at one side of the detection drone and applying, when a mine is detected, the fluorescent material at the same time as mapping the location of the mine, an effect of enhancing accuracy of detecting mines by installing a distance sensor in the detection drone to move along a terrain to detect mines laid on or under the ground so that the detection drone may fly at an altitude within a predetermined range from the ground by the distance sensor, and an effect of enhancing accuracy of removing mines by installing a separate mine detector in an explosive contained in a container box at one side of the removal drone and additionally configuring a driving device so that the explosive itself may detect and move to the exact location of a mine and explodes by itself.

What is claimed is:

1. A drone for detecting and removing mines, the drone comprising:
a detection drone 10 equipped with a mine detection device 20 capable of detecting a mine M laid on or under the ground; and
a removal drone 30 for removing the mine by explosion of an explosive by dropping the explosive 40 at a location of the mine secured by the detection drone 10, wherein
the removal drone 30 waits at a predetermined distance from the explosive after the explosive 40 is installed, monitors an explosion process of the explosive exploded by a command of the control unit, sends monitored information to the control unit, and confirms whether the mine M remains after explosion of the explosive 40.

2. The drone according to claim 1, wherein the detection drone 10 flies from the ground, detects a mine using a magnetic field sensor, and maps a location of a detected mine and applies a fluorescent material at the same time, and the removal drone 30 installs the explosive 40 around the mine using information on mapping the location and applying the fluorescent material by the detection drone 10, and then removes the mine M by exploding the explosive 40 according to a command of the control unit.

3. The drone according to claim 1, wherein the detection drone 10 is equipped with a distance sensor to move along a terrain to detect the mine M laid on or under the ground, and flies at an altitude within a predetermined range from the ground by the distance sensor.

4. The drone according to claim 1, wherein the removal drone 30 is provided with a container box 31 capable of storing the explosive 40, the explosive 40 stored in the container box 31 is stored in a shock absorbing box 32 not to be randomly exploded by an external shock, and the explosive 40 is configured of an explosive body 41 for storing gunpowder 45 and grape bullets 47, an electronic detonator 46 for exploding the gunpowder 45, a wheel 42 and a driving means 43 for moving the explosive body 41, a mine detector 44 for detecting an exact location of a mine, and a communication device 48 for communicating with the control unit.

5. The drone according to claim 1, wherein the detection drone 10 and the removal drone 30 are provided with a temperature sensor, a humidity sensor, and a wind speed sensor at one side of the drones, and sense a temperature, a humidity and a wind speed at a location where the drone flies and sends the temperature, the humidity and the wind speed to the control unit.
